(19) United States
(12) Patent Application Publication
(10) Pub. No.: US 2016/0262530 A1
(43) Pub. Date: Sep. 15, 2016

(54) PROCESS FOR BRUSHING TEETH

(71) Applicant: Sunil Kumar Agarwal, Navi Mumbai (IN)

(72) Inventor: Sunil Kumar Agarwal, Navi Mumbai (IN)

(73) Assignee: Mrs. Rashmi Agarwal, Navi Mumbai (IN)

(21) Appl. No.: 15/068,608

(22) Filed: Mar. 13, 2016

(51) Int. Cl. A46B 9/10; A46D 99/00; B25G 1/10; B25G 1/06; B25G 3/34

(52) U.S. Cl. CPC A46B 9/10; B25G 1/06; B25G 3/34; B25G 1/102; A46D 99/00; A46B 2200/1066

(57) ABSTRACT

Tooth Brushes available in Market come with a bent handle which does not fulfill brushing requirement. These Brushes provide side brushing. Side Brushing does not remove food particles between teeth. Also it is very difficult to brush teeth from back side of lower jaw particularly.

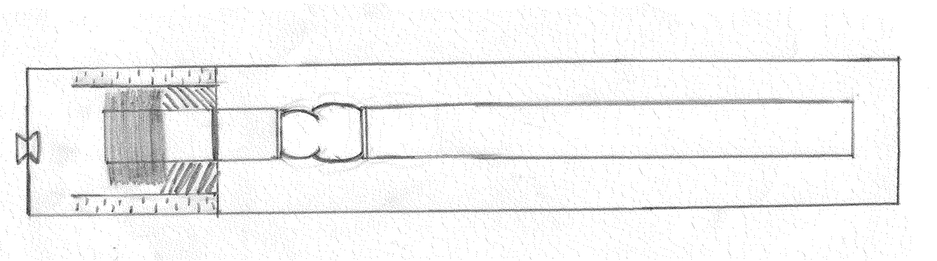

In new process, Bristles should be made on a small portion of brush head say 15 mm in round form. Bristle length may be 6 to 10 mm maximum. Tooth brush action should be to brush teeth from Upper to lower for Upper Jaw and Lower to Upper for Lower Jaw. It is this movement from Upper to Lower for Upper Jaw and Lower to Upper for Lower Jaw which will clean the teeth and not sideway motion of brush.

Sideway brushing does not remove food particles between teeth.

New process can be used to brush teeth from all sides of teeth.

Tooth Brush

Material: Any Type of Wood or Plastic

Size: Any Size

Shape: Any Shape

Colour: Any Colour

Adjustable Mechanism:

Rotation from Front of Brush with bristles facing front side

Front Rotation Angle: 20 to 40 degrees to brush back side of Lower Jaw.

Front Side Upward & Downward Twist: 15 to 30 degrees

Backward Rotation: Not Given as Brushing on Top Jaw back side can be done without bend.

No Metal Part

No Chemical

Safe for Human Use

1. I have claim on concept of Tooth Brush Adjustable Bending.
I have claim on manufacturing product without permission.
I have claim on this rotating link.
As mentioned in specification, No deviation or minor/major changes in product parameters to bypass claim on Patent.
